(19) United States
(12) Patent Application Publication
(10) Pub. No.: US 2002/0012113 A1
(43) Pub. Date: Jan. 31, 2002

(54) MAXIPRINT EASEL

(76) Inventor: ABRAHAM MARTHINUS PRETORIUS, MILTON, MA (US)

Correspondence Address: DAN CLEVELAND, LATHROP & GAGE, L.C., 4845 PEARL EAST CIRCLE, SUITE 302, BOULDER, CO, 80301, US

(21) Appl. No.: 09/237,092

(22) Filed: Jan. 25, 1999

(51) Int. Cl. G03B 27/60

(52) U.S. Cl. 355/73

(57) ABSTRACT

The invention provides a maxiprint easel. An enclosure includes a focus board to support the photographic paper. The enclosure forms an interior, and the focus board forms a series of holes connected to the interior. A vacuum port connects a vacuum source to reduce pressure within the interior, such that suction through the holes forces the paper onto the focus board when there is reduced pressure in the interior. A vacuum cleaner can be used for the source in a home setting.

### RELATED APPLICATIONS

This application is a continuing application of commonly owned and co-pending U.S. Provisional Application No. 60/072,570 filed on Jan. 26, 1998, and which is hereby incorporated by reference.

### FIELD OF THE INVENTION

The invention relates to easels for photographic darkroom printing.

### BACKGROUND OF THE INVENTION

Photographic darkrooms commonly have easels to hold photographic paper for processing. The outside perimeter of the paper is secured to the easel by a rectangular frame. The frame thus occludes the perimeter of the photographic paper, wasting recording space that might otherwise be used for imagery. The outside perimeter is typically clipped from the picture after processing completes.

One object of the invention is to eliminate the need for the frame required in prior art easels. Another object of the invention is to increase the usable space of photographic paper for print processing and imagery. These and other objects will become apparent in the description that follows.

### SUMMARY OF THE INVENTION

The invention provides a vacuum operated maxiprint easel. An enclosure is the main structure of the easel. The enclosure has a flat white focus board for placement of the photographic paper thereon. A vacuum port provides access to the interior of the easel such that a vacuum applied to the port reduces pressure within the interior. A series of holes in the focus board thus create suction for photographic paper disposed on the focus board.

In operation, photographic paper is laid upon the focus board in a manner similar to existing easels. A vacuum source, e.g., a vacuum cleaner, is connected to the port to suck air from the interior and to force the paper tightly to the focus board, thereby eliminating the need for an easel frame such as in the prior art.

In one aspect, the enclosure is made from a rigid material such as plastic or metal. In another aspect, the port is also made from a rigid material such as plastic or metal.

In yet another aspect, the focus board is substantially rectangular to accommodate generally rectangular photographic paper.

In one aspect, the port includes a generally tubular member, with an open end, that extends from the enclosure. A vacuum source is coupled to the member to draw a vacuum within the enclosure. Preferably, the source includes a hose that couples to the member.

In another aspect, the focus board is marked with a series of concentric rectangular lines which define standard photographic paper sizes. An array of holes are constructed and arranged inside the lines so that paper of each standard size is forced onto the focus board at the edges of the paper. Holes outside of the selected standard size are temporarily blocked via a rectangular template so that suction is not wasted through holes that do not assist in forcing the paper onto the focus board.

In still another aspect, the enclosure is box-like and forms an interior between the focus board, a backing board, and support strips. In one aspect, the vacuum port connects through the strips on one side of the enclosure to reduce pressure within the interior.

The invention is next described further in connection with preferred embodiments, and it will become apparent that various additions, subtractions, and modifications can be made by those skilled in the art without departing from the scope of the invention.

### BRIEF DESCRIPTION OF THE DRAWINGS

A more complete understanding of the invention may be obtained by reference to the drawings, in which:

FIG. 1 illustrates a perspective view of one maxiprint easel of the invention;

FIG. 2 shows a cross-sectional view of the easel of FIG. 1;

FIG. 3 shows another cross-sectional view of the easel of FIG. 1; and

FIGS. 4 and 5 show representative mask templates for use with the easel of FIG. 1.

### DETAILED DESCRIPTION OF THE DRAWINGS

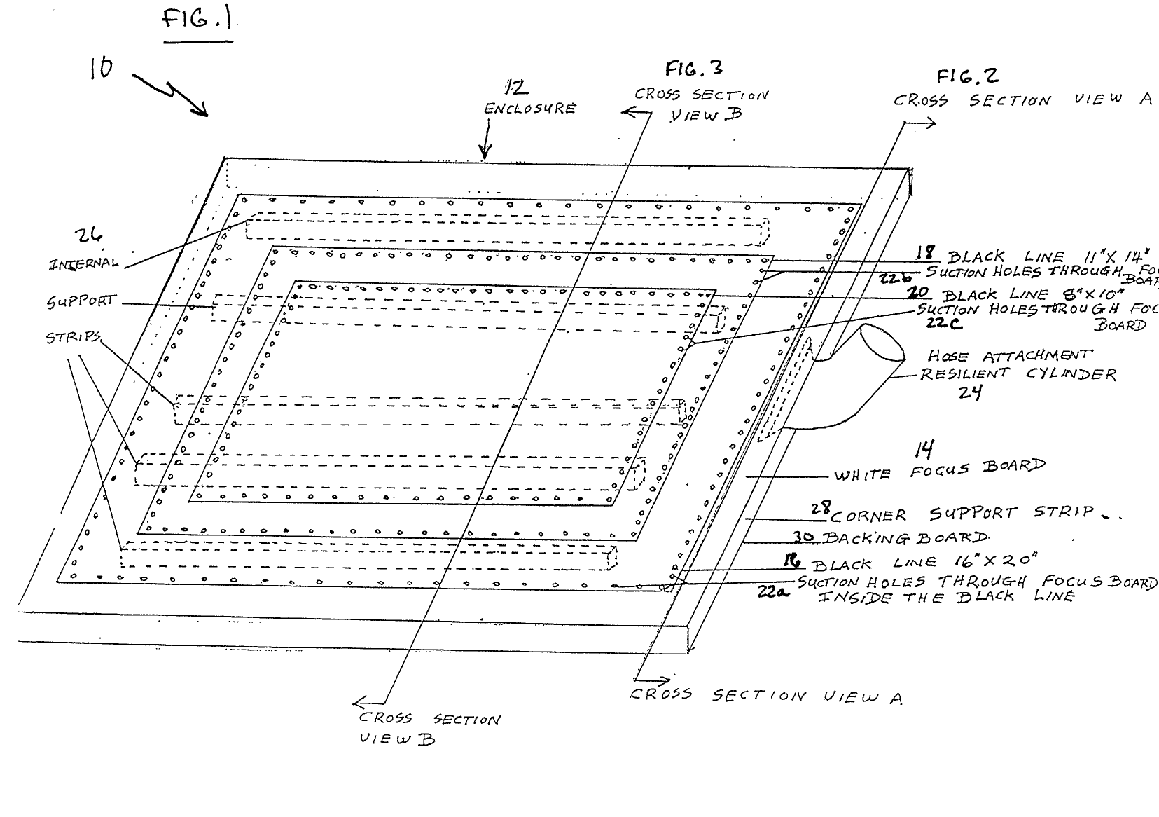

FIG. 1 shows a perspective view of an easel 10 constructed according to the invention. Generally, the easel 10 is used in conjunction with three paper sizes, 8×10 inch paper, 11×14 inch paper, and 16×20 inch paper. The easel includes a generally rectangular enclosure 12 with a flat focus board 14 disposed at a top of the enclosure 12. Three black lines disposed on the focus board 14 preferably define the relevant paper sizes for use with the easel 10, including a 16×20 line 16, a 11×14 line 18, and a 8×10 line 20. An array of holes 22 are disposed within the focus board 14 and inside each line 16, 18, 20 in order to create suction for paper disposed on the board 14: holes 22a correspond to 16×20 inch paper usage; holes 22b correspond to 11×14 inch paper usage; and holes 22c correspond to 8×10 inch paper usage. A suitable hole diameter for each of holes 22 is 7/16′ in diameter. Adjacent holes for any one line 16, 18, 20 are preferably spaced at less than one inch intervals.

The enclosure 12 forms an interior that can be de-pressurized by a vacuum through the hose attachment cylinder 24. Specifically, a vacuum source (e.g., a vacuum cleaner with a hose) attached to the cylinder 24 creates a vacuum within the enclosure interior such that suction is drawn through the holes 22. Photographic paper disposed on the focus board 14 is thus forced tightly against the focus board 14, as desired in photography.

The enclosure 12 includes one or more (preferably four) internal supports 26 to prevent collapse, and a corner support strip 28. A backing board 30 completes the enclosure 12 to form the interior therein.

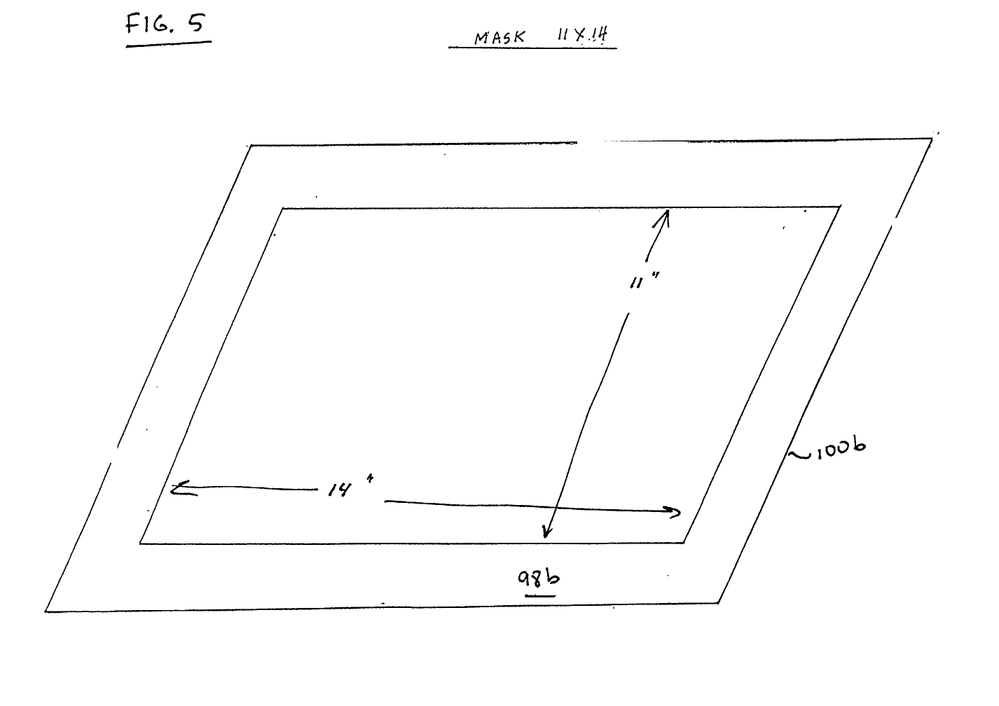

In use, photographic paper of the desired size is placed onto the focus board 14. If the paper is smaller than the largest size—i.e., 16×20 inches—then a mask template is also placed onto the focus board to block holes 22 that are outside the selected paper size. FIGS. 4 and 5 show, respectively, mask templates 98a for 8×10 inch paper and mask template 98b for 11×14 inch paper. The outer perimeter 100a of template 98a fits on the easel 10 to cover holes 22c and 22a to block suction therethrough. The outer perimeter 100b of template 98b fits on the easel 10 to cover holes 22a to block suction therethrough.

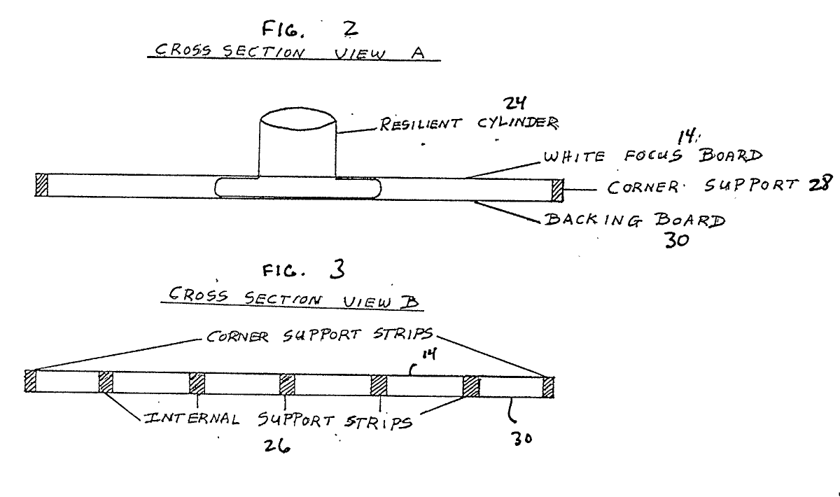

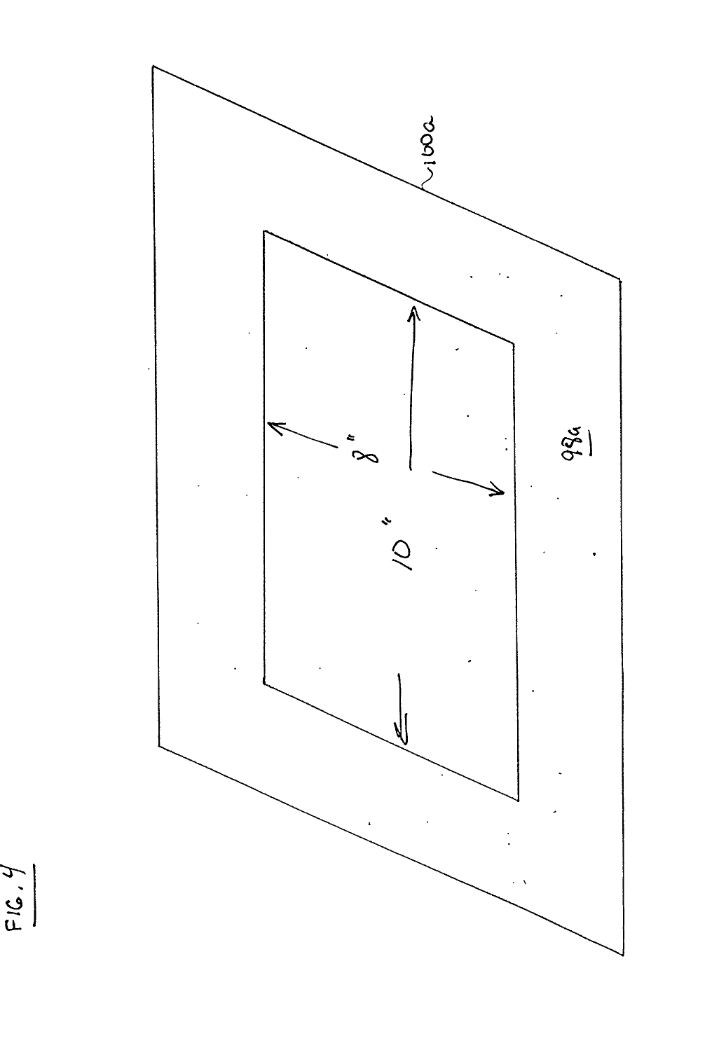

FIG. 2 shows a cross sectional view of the easel 10, including a view of the cylinder 24, focus board 14, backing board 30, and corner support 28. FIG. 3 shows a cross sectional view of the easel 10, including a view of the focus board 14, backing board 30, and internal support strips 26.

The invention thus attains the objects set forth above, among those apparent from preceding description. Since certain changes may be made in the above systems and methods without departing from the scope of the invention, it is intended that all matter contained in the above description or shown in the accompanying drawing be interpreted as illustrative and not in a limiting sense.

In view of the foregoing, what is claimed is:

1. A maxiprint easel, comprising:
an enclosure with a focus board for supporting photographic paper, the enclosure forming an interior, the focus board forming a series of holes connected to the interior; and
a vacuum port for connection to a vacuum source to reduce pressure in the interior, wherein suction through the holes forces the paper onto the focus board when there is reduced pressure in the interior.

2. An easel according to claim 1, wherein the enclosure comprises one or more internal support strips to support the focus board.

3. An easel according to claim 1, wherein the enclosure comprises a backing board.

4. An easel according to claim 1, wherein the enclosure comprises a support strip.

5. An easel according to claim 1, wherein the vacuum port comprises an open-ended cylinder.

6. An easel according to claim 1, further comprising a vacuum cleaner having a hose for connection to the port.

7. An easel according to claim 1, wherein the focus board is constructed and arranged to form a series of holes in a rectangular shape slightly less than 8×10 inches.

8. An easel according to claim 1, wherein the focus board is constructed and arranged to form a series of holes in a rectangular shape slightly less than 11×14 inches.

9. An easel according to claim 1, wherein the focus board is constructed and arranged to form a series of holes in a rectangular shape slightly less than 16×20 inches.

10. An easel according to claim 1, wherein the focus board is constructed and arranged to form three rectangular patterns of holes within the focus board, a first pattern corresponding to slightly less than 8×10 inches, a second pattern corresponding to slightly less than 11×14 inches, and a third pattern corresponding to slightly less than 16×20 inches.

11. An easel according to claim 10, further comprising one or more templates for blocking one or more patterns to block suction through holes larger than a selected paper size.

12. An easel according to claim 1, wherein the focus board is constructed and arranged to form the holes at adjacent spacings that are less than about one inch.

13. A method for forcing photographic paper against an easel, comprising the steps of:
selecting a paper size and mounting the photographic paper to a focus board; and
drawing a vacuum through holes within the focus board to force the photographic paper against the focus board.

14. A method according to claim 13, further comprising the step of blocking holes through the focus board that are larger than the paper size so as to block suction through holes exterior to the paper size.
